(19) United States
(12) Patent Application Publication
(10) Pub. No.: US 2005/0216571 A1
(43) Pub. Date: Sep. 29, 2005

(54) Recording/reproducing apparatus

(75) Inventors: Meeko Kuwahara, Yokohama (JP); Junji Shiokawa, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/848,017

(22) Filed: May 17, 2004

(30) Foreign Application Priority Data
Mar. 24, 2004 (JP) 2004-085963

(51) Int. Cl. G06F 15/16

(52) U.S. Cl. 709/217; 709/227

(57) ABSTRACT

A recording/reproducing apparatus enabling to communicate with a plural number of terminal apparatuses connected thereto, comprising: a communication interface for sending information to a terminal apparatus and for receiving information from the terminal apparatus; and a control portion for controlling the recording/reproducing apparatus, wherein a notice is made to another terminal apparatus, being separate from that, which is already connected to said recording/reproducing apparatus, when connecting the another terminal apparatus to the recording/reproducing apparatus, upon communication condition made between the recording/reproducing apparatus and the terminal apparatus, which is already connected thereto. Thus, being able to peruse and/or notice the connection condition depending upon a reproducing condition (i.e., the communication condition) thereof, therefore the recording/reproducing apparatus can provide usability more advantageous or favorable for a user.

### FIELD OF THE INVENTION

The present invention relates to a network technology of enabling transmission of data with using communication technologies.

### BACKGROUND OF THE INVENTION

In general communication technologies, in particular, for an apparatus, being made up with a plural number of parts thereof and having a communication function therebetween, there is already known a technology that restriction on a number of connections and/or division on processes/transmission paths are/is set up, automatically, on the apparatus side, or set up by a manager who manages the apparatus, in particular, in cases where terminal devices are connected to a main apparatus in a plural number thereof, so as to be used, and/or when a number of recording channels or the terminal apparatuses is increased, and in particular, if it exceeds the processing capacity of the apparatus. Such the technology is already known, in Japanese Patent Laying-Open No. 2003-179872 (2003), for example.

### BRIEF SUMMARY OF THE INVENTION

However, with such the conventional technology, in particular, a recording/reproducing apparatus having a communication function between a plural number of terminal devices or apparatuses, since it is impossible for a user to alter or change the condition on recording/reproducing thereof, at each side of the devices or apparatuses connected thereto, depending upon the situation thereof, through setting up a condition within the recording/reproducing apparatus, in the cases when the number of recording channels and/or the terminals at which communications are conducted, and in particular, when it exceeds the processing capacity of the apparatus; therefore, it brings about the apparatus being bad or inferior in the usability thereof.

An object is, according to the present invention, therefore, to provide a network technology for improving the usability of such the apparatus.

According to the present invention, for accomplishing the object mentioned above, there is provided a recording/reproducing apparatus enabling to communicate with a plural number of terminal apparatuses connected thereto, comprising: a communication interface being configured to send information to a terminal apparatus and to receive information from said terminal apparatus; and a control portion being configured to control said recording/reproducing apparatus, wherein a notice is made to another terminal apparatus, being separate from that, which is already connected to said recording/reproducing apparatus, when connecting said another terminal apparatus to said recording/reproducing apparatus, upon communication condition made between said recording/reproducing apparatus and said terminal apparatus, which is already connected thereto.

Preferably, according to the present invention, in the recording/reproducing apparatus as described in the above, a notice is made to said another terminal apparatus that information cannot be transmitted from said recording/reproducing apparatus, when the information cannot be transmitted from said recording/reproducing apparatus to said another terminal apparatus.

Also, preferably, according to the present invention, in the recording/reproducing apparatus, as described in the above, a notice is made to said terminal apparatus, which is already connected to said recording/reproducing apparatus, that said another terminal apparatus is connected to said recording/reproducing apparatus, when said another terminal apparatus is connected to said recording/reproducing apparatus.

Also, preferably, according to the present invention, in the recording/reproducing apparatus, as described in the above, said another terminal apparatus and said terminal apparatus, which is already connected to said recording/reproducing apparatus is able to transmit information therebetween through said communication interface.

And also, preferably, according to the present invention, in the recording/reproducing apparatus, as described in the above, communication condition between said recording/reproducing apparatus and said terminal apparatus connected thereto is changed upon basis of information relating to a condition of communication which is transmitted from said terminal connected thereto.

According to the present invention, the plural number of apparatuses, each having the communication function and building up a network, can always hold the condition of each of those apparatuses; therefore, it contributes to an effective use of those apparatuses at the maximum in the capacity thereof, and also improving the usability for the users thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the structure of a network, according to a first embodiment of the present invention;

FIG. 2 shows a flowchart for showing a first example of the flows, in particular, of display screens in the proceeding of communication processes and when processing the communication, in the first embodiment according to the present invention;

FIG. 3 shows a flowchart for showing a second example of the flows, in particular, of display screens in the proceeding of communication processes and when processing the communication, in the first embodiment according to the present invention; and

FIG. 4 is a block diagram for showing an example of the structure built up, according to a second embodiment of the present invention.

### DETAILED DESCRIPTION OF THE INVENTION

Hereinafter, embodiments according to the present invention will be fully explained by referring to the attached drawings.

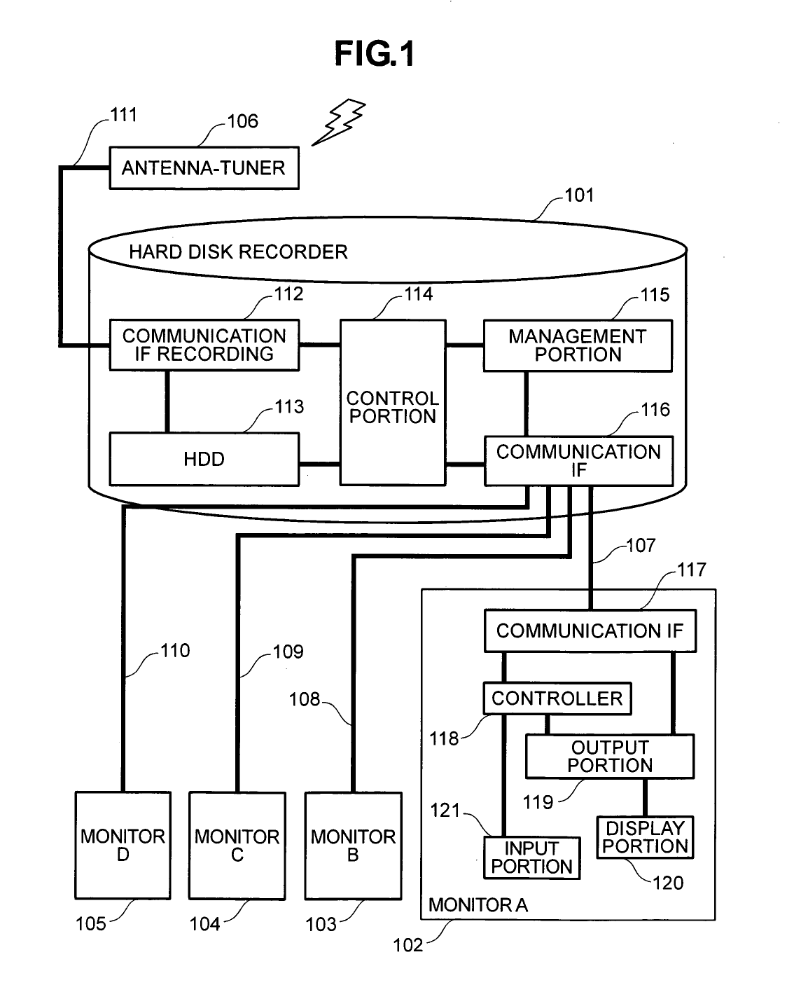

FIG. 1 is a block diagram for showing the structure of a network, being made up, according to a first embodiment of the present invention.

In this FIG. 1, a reference numeral 101 depicts a hard disk recorder 101, having a communication function to be a main part of communication, and also being able to record/reproduce AV (Audio Visual) data onto/from, and 102 a monitor having a communication function, being connectable to the hard disk recorder and reproduce the AV data therein. A monitor B 103, a monitor C 104 and a monitor D 105 have also the same function thereof. A reference numeral 106 is an antenna/tuner 105 for receiving the AV data from an outside and transmitting recording data to the hard disk recorder 101, and 107-111 communication paths for connecting between each of the monitors 102 to 107 and the hard disk recorder 101, respectively.

A reference numeral 112 is a communication interface for transmitting a request of the hard disk recorder 101 and for receiving data from the antenna/tuner 106, 113 a reservation portion (for example, a hard disk drive) for storing the AV data therein, for the purpose of reservation, and for reproducing it to be outputted therefrom (hereinafter, being called by “HDD”), 114 a control portion for managing the communication condition between each of the monitors and the hard disk recorder 101, 106 a communication interface, through which the hard disk recorder 101 conducts the reproduction of AV data and also the communication between the apparatuses, i.e., the monitors 102 to 105, 117 a communication interface, through which the monitor A 102 conducts the communication between the hard disk recorder 101, as well as, the reproduction of AV data and the communication between the apparatuses, 118 is a controller for use of operation of the monitor A 102, 119 an output portion of data, for displaying the data within the monitor A 102, 120 a display portion of data within the monitor A 102. A user can operates the monitor A 102 through operating upon an input portion 121 thereof. This input portion 121 may be made up, by mounting an operation button(s) or a keyboard, for example, on the monitor A 102, or it may be made up with a receiver circuit for receiving an operation signal generated from a remote controller. Also, the control portion 114, the management portion 115, the controller 118 and the output portion 119 may be made up with a circuit for exclusive use thereof, i.e., in the form of hardware, or it may be made up with a CPU (Central Processing Unit), a MPU (Micro Processing Unit) etc., having a memory thereof, for executing a program therein, i.e., in the form of software.

The hard disk recorder 101 has a communication function, and it is connectable with terminal devices or apparatuses (such as, the monitors in the present embodiment) in a plural number thereof, while being controlled by the control portion 114, and thereby achieving a role of a main apparatus in the network, according to the present embodiment.

Each of the monitors 102 to 105, being connected with the hard disk recorder 101, can receives the recording data stored within the recording data reservation portion 113 of the hard disk recorder 101, and also can display the data on the display portion 120 thereof. Also, each of the monitors can make communication, mutually, through the communication interface 116 of the hard disk recorder 101.

The management portion 115 provided within the hard disk recorder 101 makes management upon the communication condition between the hard disk recorder 101 and the monitors 102 to 105. The controller of the monitor A 102 is able to set up the communication condition between the hard disk recorder 101, on whether being published or not. The setup relating to the publication/non-publication of the communication condition, which is set up by the controller 118, is managed within the management portion 115 in the hard disk recorder 101. Since other monitors 103 to 105 also have the same function as was mentioned above, and the hard disk recorder 101 manages the communication condition of each of the monitors, therefore, the hard disk recorder 101 is able, not only to communicate the communication condition with the management portion 115 through connection to the hard disk recorder 101, but also able to select to transmit or not the communication condition to the other(s) under control of the controller 118, and further, it can grasp or hold the communication conditions of other monitor(s) connected thereto, through communicating the published information between the management portion 115. Also, since the communication can be done among the monitors through the communication interface 116 of the hard disk recorder 101, therefore it is possible to achieve a communication, such as, about changing of the condition or a negotiation, etc., with each of the apparatuses, under the operation of the controller, thereby enabling to change the method of reproducing the recording data depending upon the condition.

Herein, the communication condition in the present embodiment, it indicates a kind or sort of the AV data to be displayed on the monitor, a transmission rate of that AV data, a program for reproducing-sequence of the AV data, a connection time to the hard disk recorder 101, a prospected connection time, and a transmission capacity of the communication path, etc.

For example, when staring the connection operation under the operation of the controller, the monitor A 102 makes a notice of connection to the other monitors 103 to 105 connected thereto, thereby informing the start of the connection operation. Also, when the connection can be established, notification is made upon a notice of establishing the connection and also the number of the monitors, which are connected thereto at the time when the connection is established. Each of the monitors 102 to 105 connected thereto is able to produce a reproducing program of itself, by referring to the reproducing program for reproducing the recording data in each of the monitors, which is managed within the management portion 115 thereof, when producing a program for reproducing-sequence of the recording data, etc., and it is also able to know a limit of processing on the hard disk recorder 101, by reading or perusing the information, which the control portion 114 of the hard disk recorder 101 manages within the management portion 115 thereof. With doing so, it is possible to reduce the number of the reproducing programs, by paying the consideration of a side of the monitors, thereby increasing the number of the monitors displaying the AV data thereon.

As an example, it is assumed that the hard disk recorder 101 has a processing capacity of reproducing the AV data stored within the reservation portion 113 by three (3) pieces thereof, at the maximum picture quality, and that the information of this processing capacity is managed within the management portion 115. In a case where the hard disk recorder has been already outputting the AV data at the maximum picture quality to the monitors 103 to 105, therefore being in the condition that it cannot accept the connection with the monitor, no more; and then, if the monitor A 102 makes a connection request to the hard disk recorder 101, then the control portion 114 gives a BUSY notice to the monitor A 102, that the hard disk recorder 101 cannot accept the connection any more, by referring to the information within the management portion 115. In that instance, the user of the monitor A 102 can selects one from the following; i.e., to end the connection operation as it is, to read or peruse the communication information of the apparatuses connected thereto which are managed within the management portion 115, or to make a negotiation request. When she/he selects the ending of the connection, then the connection operation is ended. In a case when she/he selects to peruse the communication information managed within the management portions of other monitors 103 to 105 connected thereto, then the information is displayed about the other monitors 103 to 105; such as, the sequence of reproduction of the recording data, the connection time, the prospected connection time, the reproducing condition, etc. In that instance, the user can select one from the followings; i.e., to end up the connection, to continue the connection operation under the condition, being completely same to the reproducing condition of any one of the monitors 103 to 105, or to make a negotiation request. In a case where the negotiation request is selected, then that negotiation request is transmitted to the monitors 103 to 105 through the hard disk recorder 101. Upon receipt of the negotiation request, each of the monitors 103 to 105 makes selection, on whether it allows the negotiation or refuses it. In a case where the negotiating is allowed, a notice of allowance is transmitted to the monitor A 102, and thereby the negotiation is started between the monitor A 102 and the monitor, which allows the negotiation, under the control of the controller 118. In case of refusing the negotiation, since a notice of refusal is transmitted to the monitor A 102, then the user of the monitor A 102 must end up connection of the monitor A 101 to the hard disk recorder 101, or continues the connection operation under the condition, being same to that of those monitors 102 to 104, which are already connected to the hard disk recorder 101.

However, the main electronic apparatus should not be restricted only to the hard disk recorder 101, and also the electronic terminals apparatuses mentioned above should not be restricted only to such the monitors as was mentioned above. Also, the communication paths 107 to 110 may be made up with using only one communication path, or in the place thereof, a pair of paths, one thereof being for excusive use of communication made between those apparatus, and the other thereof for excusive use of reproducing the recording data. Further, the communication paths 107 to 110 may be obtained through wires or radio waves (wireless); thus, the transmission method thereof is out of the question. Moreover, the controller 115 may be installed or amounted within an inside of the monitor A 102, or may be formed into a body separating from a housing of the monitor A 102.

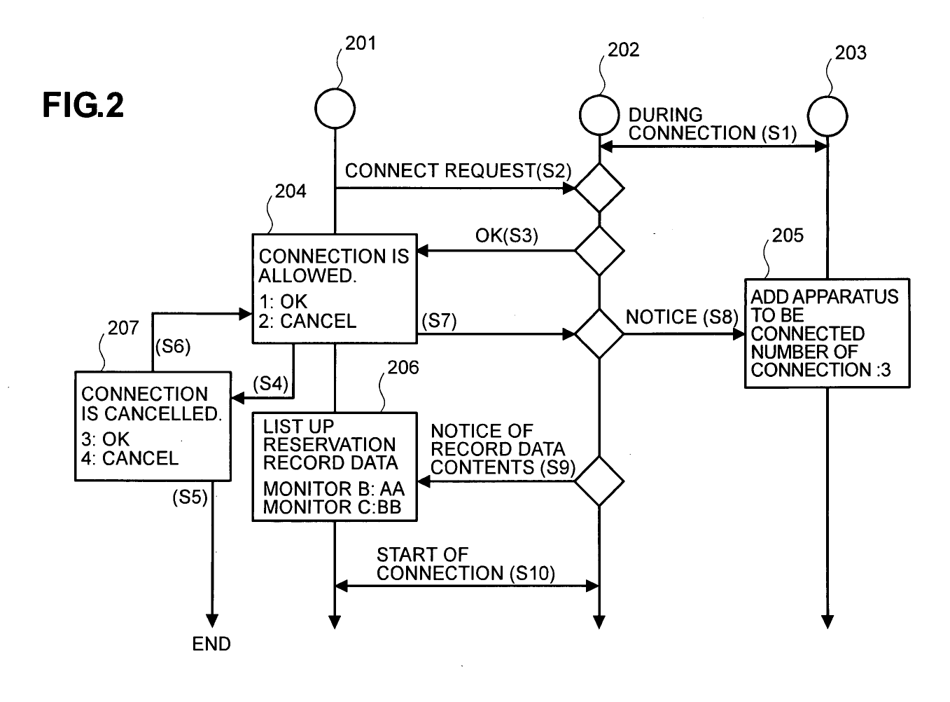

FIG. 2 shows one example of the flows for showing a progress or processing of the communication processes and the display screens when conducting the communication processes within the network, according to the first embodiment. However, except for the cases of clearly mentioning thereabout in particular, those communication processes within the hard disk recorder 101 are conducted under the control of the control portion 111, while the communication processes of the monitor A 102 under the control of the controller 115. The monitor B 103, the monitor C 104 and the monitor D 105 are same to that of the monitor A 102.

In FIG. 2, a reference numeral 201 shows the processing and the display screens, when conducting the communication processes within the monitor A 102, and also a reference numeral 202 depicts the proceeding and the display screens when conducting the communication processes in the hard disk recorder 101, and a reference numeral 203 the proceeding and the display screens when conducting the communication processes within the monitors 103 and 104, which were already established on the connection between the hard disk recorder 101, and have been displaying the AV data received from the hard disk recorder 101 on the display portions thereof.

Assuming that the hard disk recorder 101 has already been connected with the monitors 103 to 105, while setting up the allowance of publication about the communication information held within the management portion 115, and when the hard disk recorder 101 is conducting the reproduction of recording data (step S1), then the monitor A 102 transmits the connection request to the hard disk recorder 101 (step S2). In that instance, in a case where it is within the limit of the processing capacity of the hard disk recorder 101, even if the control portion within the hard disk recorder 101 connects the monitor A 102 therewith, then a notice of connection “OK” is transmitted from the control portion 114 of the hard disk recorder 101 to the monitor A 102 (step S3), and then the monitor A 102 displays a screen 204 on the display portion thereof, under control of the controller 118.

For starting the communication, the user of the monitor A 102 must select one between “1: OK” and “2: Cancel”, through operating upon the input portion 121. In a case when the “2: Cancel” is selected (step S4), a confirmation screen 207 is displayed, and then she/he selects one, between “3: OK” and “4: Cancel”. In a case when the “3: OK” is selected, the connection to the hard disk recorder 101 is ended up (step S5), on the other hand when the “4: Cancel” is selected, the screen 204 is displayed, again, thereby prompting her/him to make the selection, once again (step S6). In a case when the “1: OK” is selected, a notice of starting the connection is made to the hard disk recorder 101 (step S7), and in that instance, and also a notice is transmitted to the monitors 103 to 105 from the hard disk recorder 101, of increasing a number of the monitors connected thereto (step S8), while the monitors 103 to 105 display the screen 205 on the display portions thereof.

Next, the hard disk recorder 101 transmits the contents of the AV data recorded within the reservation portion 113 to the monitor A 102 (step S9). The monitor A 102 display the contents of the AV data, such as, a screen 205, for example. The user of the monitor A 102 produces a reproduction program of the AV data at her/his desire, by referring to the screen 206, and operates the input portion 121 to transmit the reproducing program to the hard disk recorder 101. The hard disk recorder 101 transmits the AV data to the monitor A 101 upon the basis of the reproducing program transmitted thereto. In this manner, the connecting is started between the monitor A 102 and the hard disk recorder 101 (step S10).

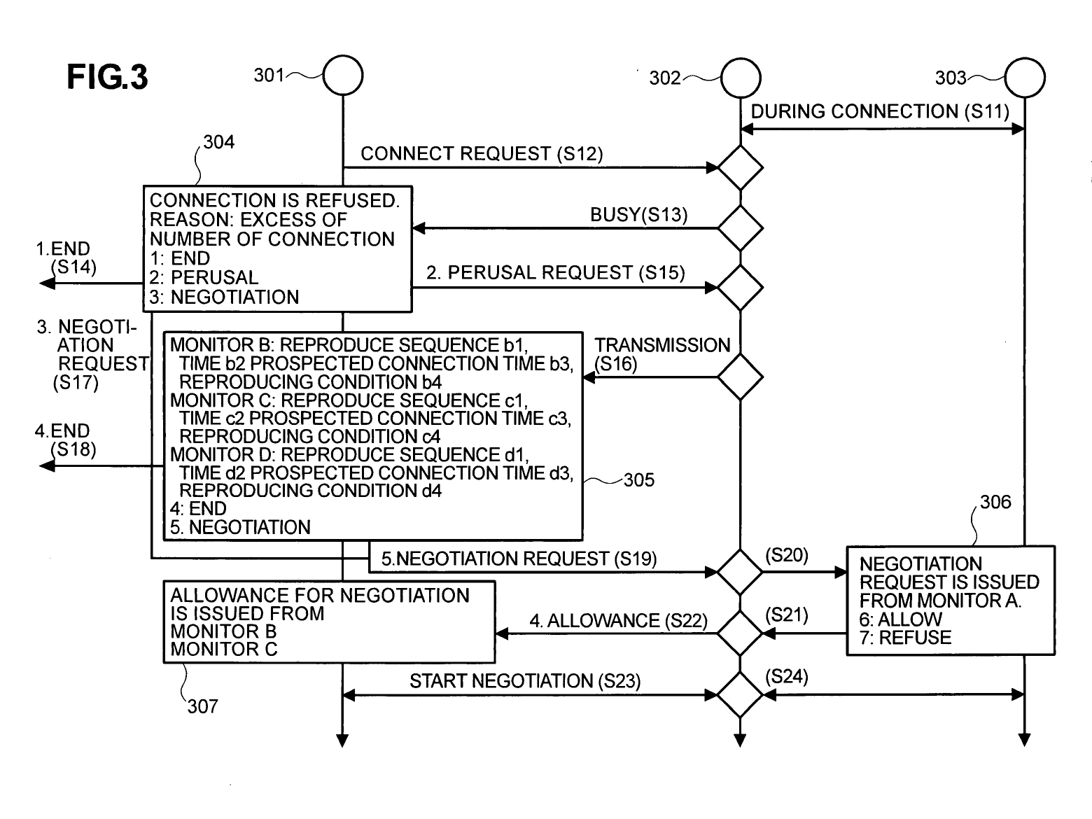

FIG. 3 shows a second example of the flows of the display screens shown when proceeding and conducting the communication processes in the network of the embodiment 1. This second example shows one of the cases, where the hard disk recorder 101 has a limit in the processing capacity thereof, and in particular when it exceeds the processing limit thereof if the monitor A 101 makes the connection thereto. However, except for the cases where clear mentioning is made in particular, it is assumed that the communication processes of the hard disk recorder 101 are conducted under the control of the control portion 111 thereof, while the communication processes of the monitor A 102 under the control of the controller 115. The monitor B 103, the monitor C 104 and the monitor D 105 are also same to that of the monitor A 102.

In FIG. 3, a reference numeral 301 depicts a display screen shown when proceeding and conducting the communication processes in the monitor A 102, 302 a display screen shown when proceeding and conducting the communication processes in the hard disk recorder 101, 303 a display screen shown when proceeding and conducting the communication processes in the monitors 103 to 105, which have already established the connection between the hard disk recorder 101 and are displaying the AV data received from the hard disk recorder 101 on the display portions thereof.

Assuming that the hard disk recorder 101 has already been connected with the monitors 103 to 105, while setting up the allowance of publication about the communication information within the management portion 115 thereof, and when the hard disk recorder 101 is conducting the reproduction of AV data (step S11), then the monitor A 102 transmits the connection request to the hard disk recorder 101 under control of the controller 118 (step S12). In that instance, the hard disk recorder 101 transmits the BUSY notice to the monitor under the operation of the control portion 114 (step S13), and then the monitor A 102 displays the display screen 304 on the display portion 120 thereof. Since the connection is refused due to excess in the processing, therefore upon the monitor A 102 must be selected one from the followings; i.e., “1: End”, “2: Peruse” and “3: Negotiation”.

In a case when the user of the monitor A 102 selects the “1: End” through operating upon the input portion 121, then processing is conducted for ending up the connection (step S14). In a case when she/he selects the “2: Peruse”, a perusal request is transmitted to the hard disk recorder 101 (step S15). Upon receipt of the perusal request, the hard disk recorder 101 transmits the information about the monitors 103 to 105 managed within the management portion 115 thereof to the monitor A 102 under control of the control portion 114 (step S16).

The monitor A 102 displays the information of those monitors 103 to 105 on the display portion 120, such as, the sequence of reproducing the recording data, the connection times, the prospected connection times, the reproducing condition (i.e., the communication condition), etc., being like a screen 305. In that instance, the user of the monitor A 102 can select on among the followings; i.e., to “4: End” the connection, or to continues the connection under the condition being same to that of outputting the AV data to any one of the monitors 103 to 105, or make the “5: Negotiation” through operating upon the input portion 121.

In a case when the “4: End” is selected, the process is executed, being similar to that which is done when the “1: End” is selected (step S18). In a case where the “3: Negotiation” or the “5: Negotiation”, the negotiation request is transmitted to the monitors 103 to 105 through the hard disk recorder 101 (steps S17, S19 and S20). Upon receipt of the negotiation request, each of the monitors 103 to 105 displays a screen 306 on the display portion 120 thereof. The user of each of the monitors 103 to 105 can select one; between “6: Allow” or “7: Refuse”, while watching on the screen 306. In a case where anyone of the users of the monitors 103 to 105 selects “6: Allow” through operating upon the input portion 121, then the notice of allowance is displayed on the monitor A 102 (steps S21 and S22). The monitor A 102 displays a screen 307 on the display portion 120 thereof. The monitor allowing the negotiation request from the monitor A 102 stars the negotiation under control of the controller (steps S23 and S24).

As a result of the negotiation, if a user of the monitor allowing the negotiation request accepts to stop the outputting of AV data, or to change the reproducing condition (i.e., the communication condition), such as, by lowering the picture quality, etc., for example; then, such the change or alternation of the communication condition is transmitted from the monitor allowing that negotiation request to the hard disk recorder 101. Also, accompanying the change or alternation of the reproducing condition (i.e., the communication condition), the information about the reproducing condition is noticed from the monitor A 102 to the hard disk recorder 101; such as, the kind of AV data, and the picture quality thereof to be received by the monitor A 102. Upon receipt of that notice, the control portion 114 of the hard disk recorder 101 renews the contents of the reproducing condition (i.e., the communication condition), which is managed within the management portion 115 thereof. And then, the hard disk recorder 101 transmits the AV data to the monitor A 102, upon the basis of the reproducing program transmitted thereto. In this manner, the connection is started between the monitor A 102 and the hard disk recorder 101.

With those mentioned above, the perusal and/or notice is made possible upon the connection condition, depending upon the reproducing condition (i.e., the communication condition), so that the communication can be achieved in each of the apparatuses; therefore, it is possible to provide a usability being advantageous or favorable for the user.

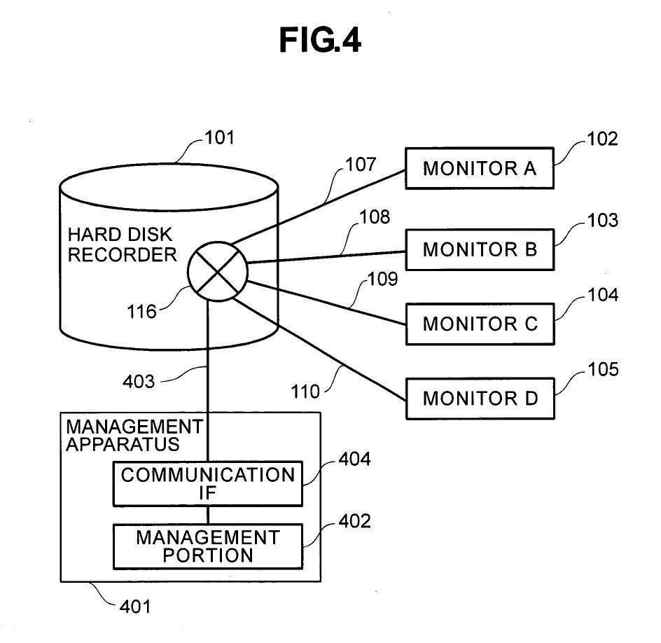

FIG. 4 is a view for showing the structure of a network, according a second embodiment of the present invention.

In this FIG. 4, an aspect, being different from the first embodiment shown in FIG. 1 mentioned above, lies in that the management portion 115, which is made up within the hard disk recorder 101, is replaced by a management portion 402, which is provided within an apparatus 401, but separating therefrom. The apparatus 401 receives a request notice from the control portion 114 of the hard disk recorder 101 through the communication interface 116, a communication path 403, and a communication interface 404, and then the apparatus 401 receiving that request notice transmits the information about the communication condition, which is managed within the management portion 402, to the control portion of the hard disk recorder 101 through the communication interface 404, the communication path 403, and the communication interface 116.

Other structures and the processing processes are same to those in the embodiment 1 mentioned above, and therefore explanation thereof will be omitted herein.

Similar effects can be obtained to that of the embodiment 1, also in a case where the management portion 413 is located within an outer apparatus 411 other than that apparatus 401; i.e., the perusal and/or the notice can be made upon the connection condition depending on the condition, and therefore achieving the communication among the apparatuses with using those enables to provide a usability being advantageous or favorable for the user.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. A recording/reproducing apparatus enabling to communicate with a plural number of terminal apparatuses connected thereto, comprising:
a communication interface being configured to send information to a terminal apparatus and to receive information from said terminal apparatus; and
a control portion being configured to control said recording/reproducing apparatus, wherein
a notice is made to another terminal apparatus, being separate from that, which is already connected to said recording/reproducing apparatus, when connecting said another terminal apparatus to said recording/reproducing apparatus, upon communication condition made between said recording/reproducing apparatus and said terminal apparatus, which is already connected thereto.

2. The recording/reproducing apparatus, as described in the claim 1, wherein
a notice is made to said another terminal apparatus that information cannot be transmitted from said recording/reproducing apparatus, when the information cannot be transmitted from said recording/reproducing apparatus to said another terminal apparatus.

3. The recording/reproducing apparatus, as described in the claim 1, wherein
a notice is made to said terminal apparatus, which is already connected to said recording/reproducing apparatus, that said another terminal apparatus is connected to said recording/reproducing apparatus, when said another terminal apparatus is connected to said recording/reproducing apparatus.

4. The recording/reproducing apparatus, as described in the claim 1, wherein
said another terminal apparatus and said terminal apparatus, which is already connected to said recording/reproducing apparatus is able to transmit information therebetween through said communication interface.

5. The recording/reproducing apparatus, as described in the claim 1, wherein
communication condition between said recording/reproducing apparatus and said terminal apparatus connected thereto is changed upon basis of information relating to a condition of communication which is transmitted from said terminal connected thereto.
